(19) United States
(12) Patent Application Publication
(10) Pub. No.: US 2008/0205861 A1
(43) Pub. Date: Aug. 28, 2008

(54) METHOD AND APPARATUS FOR RECORDING OPTICAL DISC

(75) Inventor: Kyung-hoon KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/877,696

(22) Filed: Oct. 24, 2007

(30) Foreign Application Priority Data
Feb. 27, 2007 (KR) 10-2007-0019895

(51) Int. Cl. H04N 5/781; G06F 3/00

(52) U.S. Cl. 386/126; 715/719

(57) ABSTRACT

Provided are an apparatus and method of recording an optical disc. The apparatus includes a reader which reads image files defined by a user from a storage medium, in which the image files are stored, a screen information generator which generates title menu screen information using the read image files, and a record controller which records the generated title menu screen information on the optical disc.

This application claims priority from Korean Patent Application No. 10-2007-0019895, filed on Feb. 27, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to recording an optical disc, and more particularly, to recording an optical disc which can form a title menu screen using an image file defined by a user.

2. Description of the Related Art

Examples of an optical disc which can record high definition moving picture data include a digital video disc (DVD), a blue ray disc (BD), etc. When the moving picture data is recorded on such an optical disc, a finalizing process, which converts the moving picture data recorded on the optical disc to a format readable in a related art apparatus for reproducing an optical disc, is performed. In the finalizing process, a title menu screen, which displays each image clip recorded in the optical disc according to a corresponding thumbnail form and provides a menu about reproducing a moving picture title, is prepared.

However, in a related art apparatus for recording an optical disc, a title menu screen is prepared according to a pre-defined format. Accordingly, content, such as a background screen, a button, or a thumbnail, of the title menu screen is prepared in a format self-provided by an apparatus, and thus the title menu screen cannot reflect characteristics of the recorded moving picture data or personalities of a user.

Recently, a video camera including a related art apparatus for recording an optical disc has become widely available, and in the video camera, an image photographed by a user is directly recorded on the optical disc. In this case, a user may want to edit and prepare a title menu screen of the optical disc having recorded thereon the image photographed by the user.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus for recording an optical disc which enables a user to prepare a title menu screen in a format desired by the user using an image file defined by a user.

The present invention also provides a method of recording an optical disc which enables a user to prepare a title menu screen in a format desired by the user using an image file defined by a user.

The present invention also provides a computer readable recording medium having recorded thereon a program for executing a method of recording an optical disc which enables a user to prepare a title menu screen in a format desired by the user using an image file defined by a user.

According to an aspect of the present invention, there is provided an apparatus for recording an optical disc, the apparatus comprising: a reader which reads image files defined by a user from a storage medium, in which the image files are stored; a screen information generator which generates title menu screen information using the read image files; and a record controller which records the generated title menu screen information on the optical disc.

The apparatus may be installed in a video camera. The storage medium may be an external storage medium separated from the apparatus.

The screen information generator may generate the title menu screen information by converting the read image files to an interactive graphic data and using the result of conversion.

The image file may be at least one of a background screen, a button, and a thumbnail forming the title menu screen,

The apparatus may further comprise a user interface, in which a user selects an image file that is to be used in preparing the title menu screen from among the image files, wherein the screen information generator generates the title menu screen information using the selected image file.

According to another aspect of the present invention, there is provided a method of recording an optical disc, the method comprising: reading image files defined by a user from a storage medium storing the image files; generating title menu screen information using the read image files; and recording the generated title menu screen information on the optical disc.

The method may be performed in a video camera. The storage medium may be an external storage medium separated from the video camera.

In the generating of the title menu screen information, the read image files may be converted to interactive graphic data and the title menu screen information is generated using the result of conversion.

The image file may be at least one of a background screen, a button, and a thumbnail forming the title menu screen.

The method may further comprise a user selecting an image file that is to be used in preparing the title menu screen from among the image files, wherein in the generating of the title menu screen information, the title menu screen information is generated using the selected image file.

According to another aspect of the present invention, there is provided a computer readable recording medium having recorded thereon a program for executing the method described above.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for recoding an optical disc according to an exemplary embodiment of the present invention;

FIG. 2 is a flowchart of a finalizing process for recording an optical disc according to an exemplary embodiment of the present invention;

FIG. 3 illustrates a title menu screen according to an exemplary embodiment of the present invention; and

FIG. 4 illustrates a file structure recorded in an optical disc according to an exemplary embodiment of the present invention.

### DETAILED DESCRIPTION OF THE INVENTION

Hereinafter, the present invention will be described more fully with reference to the accompanying drawings, in which exemplary embodiments of the invention are shown.

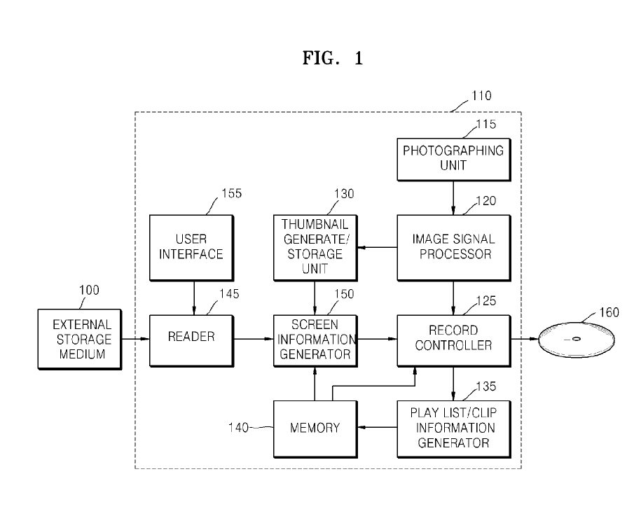

FIG. 1 is a block diagram of a vide camera 110 comprising an apparatus for recoding an optical disc according to an exemplary embodiment of the present invention. In the current exemplary embodiment, the apparatus is installed in a video camera, but the apparatus can also be installed in a personal computer, or the like. In this case, a user can record the optical disc using the person computer.

Referring to FIG. 1, the video camera includes a photographing unit 115, an image signal processor 120, a record controller 125, a thumbnail generate/storage unit 130, a play list/clip information generator 135, a memory 140, a reader 145, a screen information generator 150, and a user interface 155. The video camera 110 is connected to a separable external storage medium 100.

The external storage medium 100 stores image files, which will be used as a background screen, a button, or other element of a title menu screen, as defined by a user. The external storage medium 100 may be a compact flash (CF) memory card, a smart media (SM) memory card, an extreme digital (XD) memory card, a memory stick, a universal serial bus (USB) memory stick, a secure digital (SD) memory card, a multimedia card (MMC), etc.

The reader 145 reads data from the external storage medium 100. The reader 145 and the external storage medium 100 can be connected by a wired or wireless connection. In case of a wireless connection, a Bluetooth or a wireless universal serial bus (USB) can be used, and in case of a wired connection, a USB connection can be used.

In the current exemplary embodiment, the video camera 110 is connected to the separable external storage medium 100, but a storage medium corresponding to the external storage medium 100 may be built inside the video camera 110.

An optical disc 160, on which image data is recorded, is a disc for record and may be DVD-R/RW, DVD+R/RW, BD-R/RW, or the like. In the current exemplary embodiment, the optical disc 160 is a blue ray disc, but it is obvious that the optical disc 160 may be any disc for record.

The photographing unit 115 photographs a dynamic image and outputs an image signal as the result of photographing. The image signal processor 120 converts the image signal received from the photographing unit 115 to a digital image signal, and generates compressed image data by compressing the digital image signal. The digital image signal may be compressed according to Moving Picture Expert Group-2 (MPEG-2).

The record controller 125 records the compressed image data on the optical disc 160. In detail, the record controller 125 records image data, which is generated from the time photographing starts until the time photographing ends, in a record unit of a clip.

The play list/clip information generator 135 generates and stores play list information and clip information in the memory 140. The play list information includes time information of each clip recorded on the optical disc 160, that is, information about time reproduction starts and ends. Also, the clip information includes location information of a corresponding clip, where the clip is recorded on the optical disc 160. The location information is a physical or logical address on the optical disc 160.

The thumbnail generate/storage unit 130 generates a thumbnail by capturing a certain screen of each clip, for example, the top screen of each clip, and stores the thumbnail. The term “thumbnail” means a picture having a size of a thumbnail, in which original data having a large size is shown in a small size in order to quickly search or easily manage massive amount of image or data.

The record controller 125 performs a finalizing process in the optical disc 160. In the finalizing process, the image data recorded on the optical disc 160 is converted into a format that can be read in an apparatus for reproducing a related art optical disc. During the finalizing process, title menu screen information corresponding to the clips recorded on the optical disc 160 is generated and recorded on the optical disc 160.

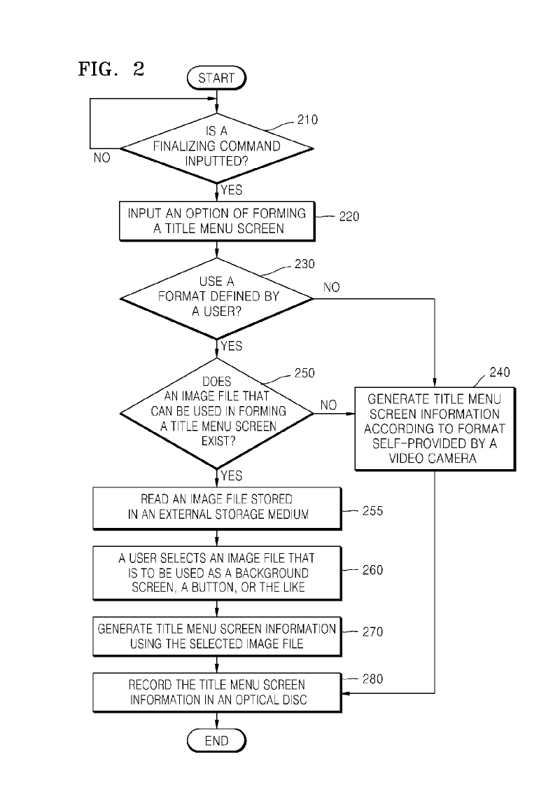

FIG. 2 is a flowchart of the finalizing process performed in the video camera 110 of FIG. 1 comprising an apparatus for recording an optical disc according to an exemplary embodiment of the present invention.

When a finalizing command is received from a user through the user interface 155 in operation 210, the user interface 155 receives a selection, as chosen by the user in operation 220, of whether to use a format self-provided by the video camera 110 or a format defined by the user as an option of forming a title menu screen.

When the selection to use the format self-provided by the video camera 110 is received in operation 230, the screen information generator 150 generates title menu screen information according to the format self-provided by the video camera in operation 240.

When the selection to use the format defined by the user is received in operation 230, the reader 145 searches for an image file, which can be used in forming a title menu screen, in the external storage medium 100 in operation 250. When an image file does not exist, operation 240 is performed.

When an image file, which can be used in forming a title menu screen, exists in the external storage medium 100, the reader 145 reads image files stored in the external storage medium 100 in operation 255.

In operation 260, the user interface 155 enables the user to select an image file, which will be used as a background screen, a button, or element of the title menu screen, from among the image files read in operation 255. When a thumbnail image file defined by a user, which can substitute a thumbnail stored in the thumbnail generate/storage unit 130, is stored in the external storage medium 100, the user interface 155 enables the user to select the thumbnail image file stored in the external storage medium 100.

In operation 270, the screen information generator 150 generates title menu screen information using the image files selected in operation 260, the thumbnail stored in the thumbnail generate/storage unit 130, and play list information and clip information stored in the memory 140. Also, when the user selects the thumbnail image file stored in the external storage medium 100 in operation 260, the title menu screen information is generates using the selected thumbnail image file as well.

Also, in operation 270, the screen information generator 150 converts the selected image files to interactive graphic data, and generates the title menu screen information using the result of conversion. The interactive graphic data is graphic data containing information related to a mutual interaction with the user.

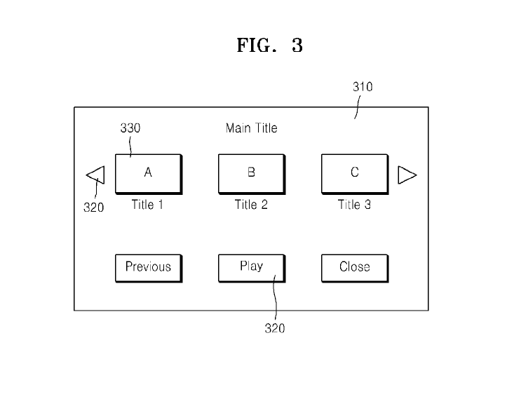

Hereinafter, operations 260 and 270 will be described with reference to FIG. 3. FIG. 3 illustrates a title menu screen according to an exemplary embodiment of the present invention. The external storage medium 100 stores image files which will be used as a background screen 310, a button 320, or a thumbnail 330. When the user selects an image file, which will be used as the background screen 310, the button 320, or the thumbnail 330, from among the image files stored in the external storage medium 100 in operation 260, the screen information generator 150 forms a title menu screen using the selected image files and generates information about a connection between clips corresponding to a button or a thumbnail of the title menu screen in operation 270.

In operation 280, the record controller 125 records the generated title menu screen information, and play list information and clip information stored in the memory on the optical disc 160.

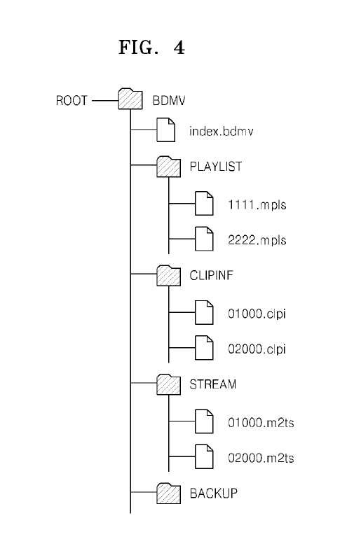

FIG. 4 illustrates a file structure recorded in the optical disc 160 according to an exemplary embodiment of the present invention. Referring to FIG. 4, a BDMV directory exists below a ROOT directory, and the BDMV directory includes an index.bdmv file for ensuring interactivity with the user. The BDMV directory also includes a PLAYLIST directory having play list information, a CLIPINF directory having clip information, and a BACKUP directory.

A stream directory includes AV stream files recorded in a certain format on the optical disc 160, in a unit of clip. Each AV stream file is recorded according to MPEG-2, and uses “.m2ts” file extension.

The CLIPINF directory includes clip information files which one-to-one correspond to the AV stream files. As described above, the clip information includes the location information of a corresponding clip, where the clip is recorded on the optical disc 160.

The PLAYLIST directory includes play list files, and each play list file includes time information of at least one clip, that is, information about time reproducing starts and ends.

The index.bdmv file includes information about a menu and a title that can be selected by the user for the title menu screen, information about time reproducing starts, location information of a file containing interactive graphic data that forms the title menu screen, etc.

The invention can also be exemplarily embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to an exemplary embodiment of the present invention, an image file defined by a user is read from a storage medium, title menu screen information is generated using the image file, and the generated title menu screen information is recorded on an optical disc. Accordingly, a user can prepare a title menu screen in a desired format, and thus a characteristic of a title menu screen can be guaranteed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for recording a recording medium, the apparatus comprising:
a reader which reads image files defined by a user from a storage medium, in which the image files are stored;
a screen information generator which generates title menu screen information using the read image files; and
a record controller which records the generated title menu screen information on the recording medium.

2. The apparatus of claim 1, wherein the apparatus is installed in a video camera.

3. The apparatus of claim 1, wherein the storage medium comprises an external storage medium separated from the apparatus.

4. The apparatus of claim 1, wherein the screen information generator generates the title menu screen information by converting the read image files to an interactive graphic data and using the result of conversion.

5. The apparatus of claim 1, wherein the image file related to at least one of a background screen, a button, and a thumbnail forming the title menu screen.

6. The apparatus of claim 5, wherein the thumbnail is generated and stored in a thumbnail generation/storage unit.

7. The apparatus of claim 5, wherein the thumbnail is stored in an external memory separated from the apparatus.

8. The apparatus of claim 1, further comprising a user interface, through which a user selects an image file that is to be used in preparing the title menu screen from among the stored image files,
wherein the screen information generator generates the title menu screen information using the selected image file.

9. The apparatus of claim 1, wherein the recording medium comprises an optical disc.

10. A method of recording a recording medium, the method comprising:
reading image files defined by a user from a storage medium storing the image files;
generating title menu screen information using the read image files; and
recording the generated title menu screen information on the recording medium.

11. The method of claim 10, wherein the method is performed in a video camera.

12. The method of claim 11, wherein the storage medium comprises an external storage medium separated from the video camera.

13. The method of claim 10, wherein in the generating of the title menu screen information, the read image files are converted to interactive graphic data and the title menu screen information is generated using the result of conversion.

14. The method of claim 10, wherein the image file relates to at least one of a background screen, a button, and a thumbnail forming the title menu screen.

15. The method of claim 10, further comprising a user selecting an image file that is to be used in preparing the title menu screen from among the stored image files,
wherein in the generating of the title menu screen information, the title menu screen information is generated using the selected image file.

16. The method of claim 10, wherein the recording medium comprises an optical disc.

17. A method of recording a recording medium, the method comprising:
inputting a finalizing command for finalizing a recording medium;
receiving a selection from a user of whether to generate a title menu screen based on a pre-preprogrammed title menu format, or to generate a title menu screen based on a title menu format defined by the user; and
recording the generated title menu screen information on the recording medium.

18. A computer readable recording medium having recorded thereon a program for executing a method of recording a recording medium, the method comprising:
reading image files defined by a user from a storage medium storing the image files;
generating title menu screen information using the read image files; and
recording the generated title menu screen information on the recording medium.
